(19) United States
(12) Patent Application Publication
(10) Pub. No.: US 2010/0088847 A1
(43) Pub. Date: Apr. 15, 2010

(54) SWIVEL CASTER

(76) Inventors: Thomas Vernon Hicks, Murrieta, CA (US); Gary Dwayne Hicks, Murrieta, CA (US)

Correspondence Address: DECKER, JONES, MCMACKIN, MCCLANE, HALL &;BATES, P.C., BURNETT PLAZA 2000, 801 CHERRY STREET, UNIT #46, FORT WORTH, TX, 76102-6836, US

(21) Appl. No.: 12/574,167

(22) Filed: Oct. 6, 2009

(30) Foreign Application Priority Data
Oct. 9, 2008 (CN) 200820134382.7

(51) Int. Cl. B60B 33/02

(52) U.S. Cl. 16/46

(57) ABSTRACT

The swivel caster includes a wheel, a yoke leg and a plastic top cap. The wheel is underneath and assembled with the yoke leg by a nut and axle which is through two axle holes of the yoke leg and the center of the wheel hub. There is an open hole in the yoke leg body so a metal shaft can bolt up inside and then be pressed into the inner hole of the plastic top cap. There is an insert molded into the yoke body hole and the upper part of the insert performs as a raceway. The king pin or metal shaft, extends through the insert and is then fixed with the plastic top cap. The raceway of the insert holds several small metal balls. The plastic top cap has a lip that forms a raceway for the small balls.

This application claims priority to application number 200820134382.7, filed Oct. 9, 2008 in the People's Republic of China.

### FIELD OF THE INVENTION

This utility model relates to a swivel caster, which is installed onto a movable device underneath and enables this device to move towards any direction. It belongs to the mechanism field.

### BACKGROUND OF THE INVENTION

Right now in order to move furniture like mop buckets, sofas, chairs, baby beds or any other devices which need to be moved, people usually install swivel casters under the devices. The existing caster also has a wheel assembled with a yoke leg. A metal shaft is fixed in the yoke leg's body longitudinally. Then the metal shaft and yoke leg are covered by a plastic top cap, which is inserted to the installation hole of the movable device. There is no displacement between the metal shaft and the yoke leg when the caster is working because they are fixed. The caster's swivel only depends on the wear point between the top of the metal shaft and one big metal ball. The fitting between the metal shaft and the plastic top cap is not so tight that friction caused by the metal shaft's turning will make two ribs inside of the top cap get smaller and smaller, and after being used for some time, the ribs are worn out and the shaft comes off from the top cap, which reduces the life expectancy of the caster. Furthermore, with this existing caster, considering the loading capacity requirement of furniture or any other movable devices, we could not add more thickness to the plastic top cap because of the installation hole's diameter and depth restriction or add more thickness to the top cap by making the metal shaft slimmer. Usually this caster is installed onto devices with high temperature. Since the top of the plastic cap thickness is thin, heated top caps often crack at the top part which is holding the metal ball when it cools down and shrinks in the installation hole, which results in a high scrap rate of the caster.

### BRIEF DESCRIPTION OF THE DRAWINGS

FIG. 1 is a cross-section of an existing swivel caster.

FIG. 2 is a rear elevation view of the caster of FIG. 1.

FIG. 3 is a cross-section of the swivel caster of the present invention.

FIG. 4 is a cross-section of the plastic top cap.

FIG. 5 is a cross-section of the yoke leg and insert.

FIG. 6 is a rear elevation view of the yoke leg.

FIG. 7 is a side elevation view of the yoke leg.

FIG. 8 is a cross-section taken through lines VIII-VIII of FIG. 7.

FIG. 9 is a bottom view of the yoke leg.

FIG. 10 is a perspective view of the swivel caster.

### DESCRIPTION OF THE PREFERRED EMBODIMENT

The technical problem solved and technical role of the present invention in overcoming the existing caster's defects, is providing a caster which is durable, not coming off easily and with low scrap rate. So the technical scheme of the present invention is as follows.

The swivel caster includes a wheel, a plastic yoke leg and a plastic top cap. The wheel is underneath and assembled with the yoke leg by a nut and axle through two axle holes of the yoke leg and the center of the wheel hub. There is an open hole in the yoke leg body so a metal shaft can bolt up inside and then be pressed into the inner hole of the plastic top cap. The technique is characterized in that there is an added sleeve-like insert molded into the yoke leg body and the upper part of the insert performs as a raceway. The king pin or metal shaft extends through the insert and is then fixed with the plastic top cap. The raceway of the insert holds several small metal balls. With this structure, when in use, there is no displacement between the metal shaft and the plastic top cap. The metal shaft, fixed with the plastic top cap can be horizontally freewheeling which depends on several small metal balls in the raceway that consists of the insert and the plastic top cap. So it overcomes the existing defect that ribs in the top cap's hole are easily worn out and then the metal shaft comes off. Plus compared with the background technique, the wear surface between the metal shaft top and the end of plastic top cap inner hole, as well as the wear surface among the small metal balls, plastic top cap and insert raceway, is much bigger, which improves not only its loading capacity but also installation performance at high temperature when being pressed into the installation hole, which leads to the low scrap rate of the caster. In addition, if necessary, the wear part between the top cap, metal balls and insert raceway can also be enhanced by adding its thickness that is helpful to get better scrap rate and life expectancy.

As an improvement and complement to the above technique scheme, the following technique scheme is characterized and added.

The insert is made of POM wearable material. Using a wearable material ensures a durable, freewheeling and long life caster.

The yoke leg, under which ribs radiate around the neck hole. Because the metal shaft bolts up inside of the yoke leg neck hole, the ribs are used to enhance the strength so it can bear the lateral effect when the metal shaft is turning.

The plastic top cap has a round bulge as the lip of the plastic top cap hole. The complete raceway accommodating small metal balls actually consists of the bulge lip and the insert. It avoids direct touch between the metal balls and the metal shaft, that helps caster freewheeling.

The plastic top cap has ribs inside the inner hole of the top cap and two grooves on the metal shaft accordingly so that they can fit into each other and get fixed when assembled.

The present invention changes the metal ball's position over the prior art, changes and enlarges the wear surface, avoids the plastic top cap coming off due to severe wear between the metal shaft and the plastic top cap's inner hole, lowers scrap rate when installation, adopts new wearable material for the wearing part, prolongs service life and this makes the caster durable, freewheeling.

To have further specification on the present invention's characteristics, please refer to the following implementation details and attached drawings.

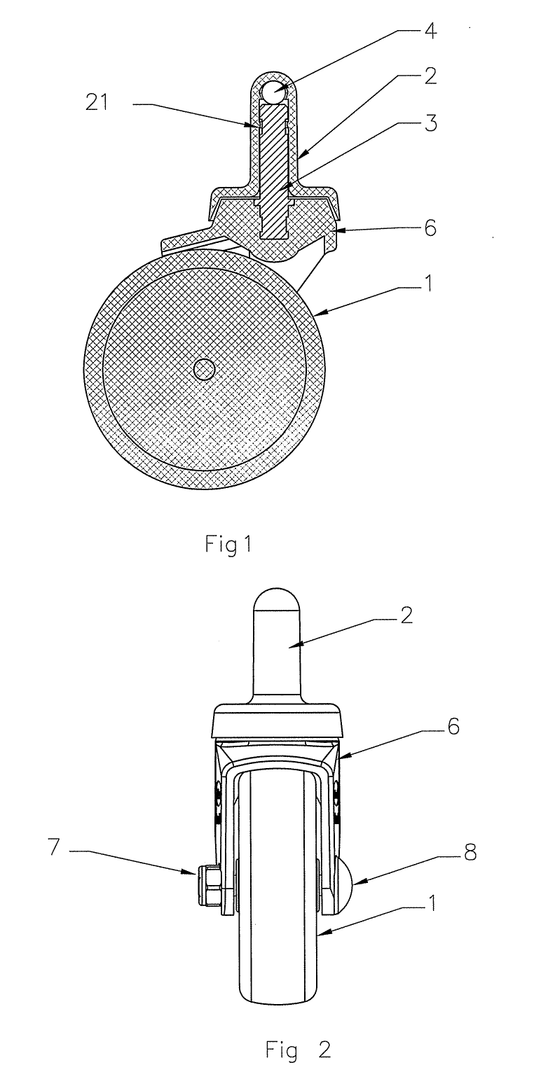

As illustrated in FIGS. 1 and 2, the prior art swivel caster includes a wheel 1, a plastic yoke leg 6 and a plastic top cap 2. The wheel 1 is underneath and assembled with the yoke leg 6 by a nut 7 and axle 8 through two axle holes of yoke leg 6 and the center of the wheel 1 hub. The bottom end of the metal shaft 3 is fixed in the yoke leg 6 body and the top end is pressed into an inner hole of the plastic top cap 2. Ribs 21 in the plastic top cap 2 and grooves on the metal shaft 3 fit into each other. Between the top of metal shaft 3 and plastic top cap 2, there is a big metal ball 4.

When in use, the metal shaft 3 and yoke leg 6 are fixed and relatively still while turning happens between metal shaft 3 and plastic top cap 2.

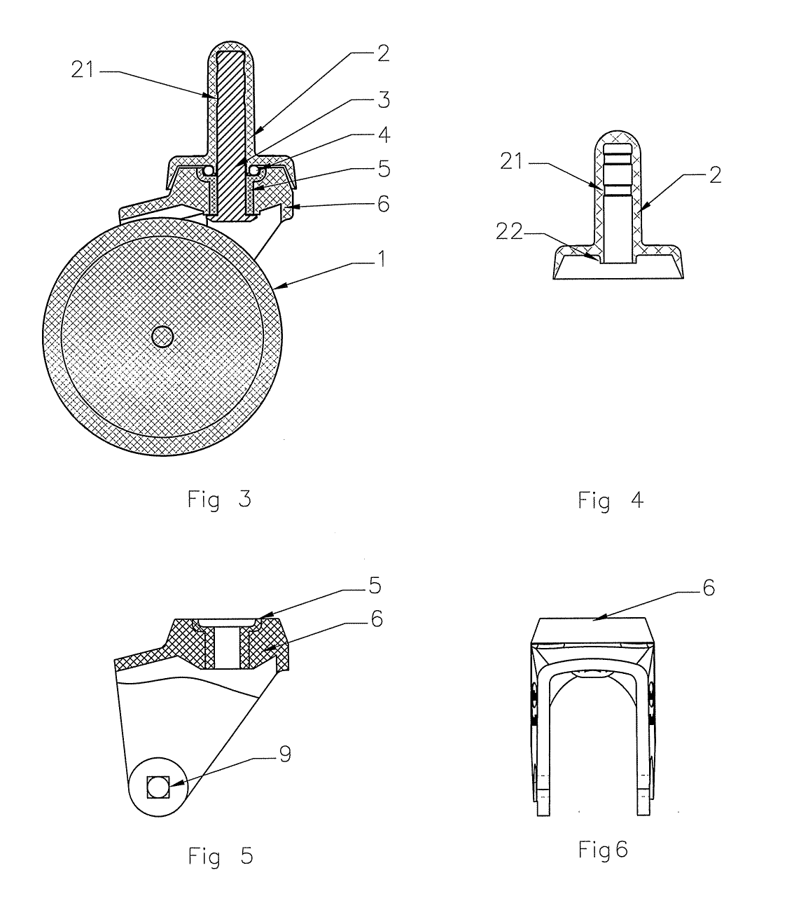

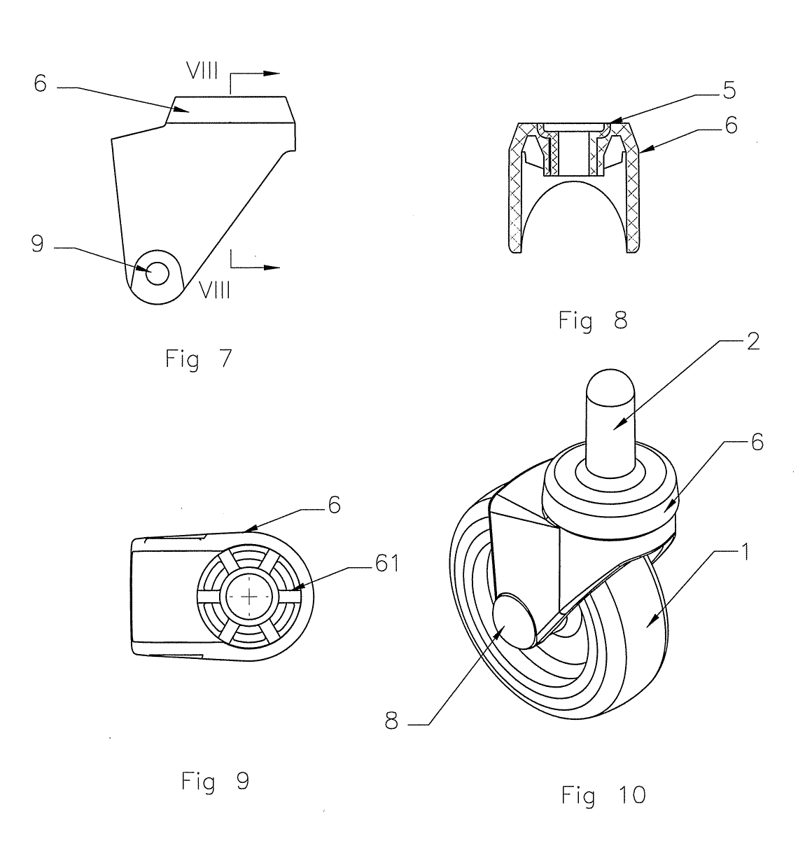

As illustrated in FIGS. 3-10, the swivel caster of the present invention includes a wheel 1, a plastic yoke leg 6 and a plastic top cap 2. Although many of the reference numbers are the same in FIGS. 1-2 and FIGS. 3-10, the use of the same reference number does not mean that the parts are identical, only that the parts are of the same type. For example, the yoke leg is numbered 6 in both FIGS. 1 and 2, and FIGS. 3-10; however the yoke leg of FIGS. 3-10 has differences not found in the yoke leg of FIGS. 1-2. The wheel 1 is underneath and assembled with the yoke leg 6 by a nut 7 and axle 8 through two axle holes 9 of the yoke leg 6 and the center of wheel 1 hub. The yoke leg is shaped like an upside down “U” as shown in FIG. 6 and has two leg portions that extend along the sides of the wheel and a top portion that bridges across the two leg portions. An insert 5 made of POM material (polyformaldehyde resin) is molded in the yoke leg 6 body, the upper part of insert 5 performs as a raceway and it holds several small metal balls 4. Metal shaft 3 or king pin, bolts up through the insert 5 hole and is pressed and fixed with the plastic top cap 2. There are radiated ribs 61 around and underneath the neck hole of the yoke leg 6. A plastic top cap 2 has a round bulge 22 as the lip of the plastic top cap 2 inner hole. Metal balls 4 lie in the raceway consisting of bulge 22 and insert 5. Plastic top cap 2 has two ribs 21 in the inner hole and accordingly two grooves on the metal shaft 3 so they can fit in each other.

When in use, the plastic top cap 2 and metal shaft 3 stay relatively still while swiveling happens between them and the yoke leg 6 with the insert 5 molded.

The caster illustrated by FIGS. 3-10 is a detailed implementation example of the present invention. It has prominent substantive features and represents a notable progress. It also could be modified in shape, specs, material and color etc. according to actual needs. Here we will not go further on this.

The foregoing disclosure and showings made in the drawings are merely illustrative of the principles of this invention and are not to be interpreted in a limiting sense.

1. A swivel caster comprising: a wheel, a plastic yoke leg, and a plastic top cap, the wheel is mounted to the yoke leg by way of an axle, the yoke leg having a neck hole, the yoke leg having an insert interchangeable with a hole through the insert, a king pin passing through the insert hole and pressed into the inner hole of plastic top cap, the insert having an upper part that is a first raceway, the top cap forming a second raceway, ball bearings located between the first and second raceways.

2. The swivel caster of claim 1, wherein the insert is made of polyformaldehyde resin.

3. The swivel caster of claim 1, further comprising radiated ribs around and underneath the neck hole of the yoke leg.

4. The swivel caster of claim 1, further comprising a lip around the second raceway of the top cap, the lip isolating the ball bearings from the king pin.

5. The swivel caster of claim 1, further comprising ribs in the top cap inner hole and grooves on the king pin shaft to fit with the ribs.
